(19) United States
(12) Patent Application Publication
(10) Pub. No.: US 2013/0052304 A1
(43) Pub. Date: Feb. 28, 2013

(54) Egg substitute and method of producing same

(71) Applicant: Weili Li, Brantford (CA)

(72) Inventor: Weili Li, Brantford (CA)

(21) Appl. No.: 13/199,195

(22) Filed: Aug. 22, 2011

(51) Int. Cl. A23J 1/12; A23L 1/0522; A23L 1/0528; A23L 1/035; A23L 1/054; A23L 1/305; A23L 1/304; A23L 1/05; A23L 1/0526

(52) U.S. Cl. 426/74; 426/656; 426/575; 426/573; 426/578; 426/654; 426/541

(57) ABSTRACT

An egg substitute composition comprising wheat protein, emulsifiers, at least one fat or oil, and polysaccharides, and optionally supplementary proteins and food gums. The composition preferably includes 1-90% wheat protein, 1-30% fat or oil and 5-30% polysaccharides. Optionally 0-50% supplementary proteins, 0-30% emulsifiers, 0-10% food gums, 0-3% reducing-oxidant agents and 0-5% calcium and ferrous salts. The composition also includes 0.01-1% sodium phosphate and disoldium phosphate in liquid form egg replacer.

### RELATED APPLICATION

This application claims priority from Canadian Application filed Aug. 18, 2011, Application Serial No. To Be Determined.

### FIELD OF THE INVENTION

The present invention relates generally to an egg substitute, and more particularly to an egg substitute having low cholesterol content for use in the preparation of aerated and non-aerated food products, and preferably an egg substitute having no cholesterol content.

### BACKGROUND OF THE INVENTION

Egg and egg protein based products are essential ingredients for the volume, texture, and shelf life of aerated food products such as muffins, cakes, cookies, breads, and various other baked products. Egg and egg protein based products are also used as ingredients in non-aerated food products such as noodles, pastas, dumplings and similar foods to provide the hardness and elasticity characteristics of these products, typically to enhance the cooking stability and shelf-life of these products. Other benefits to the use of egg and egg protein based products include providing a smoother dough, where applicable, and providing improved processing tolerances for industrial scale cooking situations.

However, it is well known that some characteristics of egg and egg products are often cause for concern, and otherwise impede the ability for some people to consume food products having egg products therein. For example, many individuals may be unable to, or would prefer not to consume egg products due to egg allergies, health concerns associated with cholesterol, culinary preferences (such as, a vegetarian or vegan diet), use of antibiotics and hormones during poultry production, and diseases associated with poultry (such as, for example, bird flu). Additionally, the high cost and/or cost fluctuations in the price of eggs and the contamination of salmonella carried by eggs have also been a concern of food manufacturers. Therefore, there is a need in the art to reduce or eliminate the content of egg and/or egg-based products in some food products.

Various egg substitutes are known in the art, but these are generally prepared with soybean proteins, milk protein and emulsifiers. Various prior art documents are described below.

Canadian patent applications CA2449906 and CA2554315 teach a composition of egg replacers used in bakery products, which include soybean proteins, vegetable oil, emulsifiers and with and without egg white.

CA1069756 discloses a composition of egg replacers, which comprises from 30% to 75% of whey protein derived by ultra-filtration/concentration, from 5% to 65% of fats having a polyunsaturated to saturated ratio of 1:1 to 2.8:1 and 0.2 to 17.0% of a food grade emulsifiers.

CA 1092432 relates to a composition and method for preparation of egg yolk extender, which is prepared with soybean flour or other flours and soybean lecithin.

CA 1113778 discloses the replacement of egg albumen in food composition with a whey protein concentrate and 0.5-15% carboxymethylcellulose.

CA 1123660 describes a composition of egg replacer in a custard product, which contains about 40% to about 60% of whey protein concentrate, from about 0.5% to about 5% carboxymethylcellulose and from about 50% to about 40% of a lactylated shortening.

U.S. Pat. No. 4,072,764 describes an egg yolk extender that comprises full fat soy flour, grain flour, lecithin. The composition can be used in the preparation of bakery products, e.g., cakes. U.S. Pat. No. 4,103,038 discloses an egg replacer composition based on ultrafiltration of whey protein, fats and emulsifier.

U.S. Pat. No. 4,120,986 describes the preparation of a high protein content material that contains 25-55% proteins, 5-15% fat and 25-50% carbohydrate, which is then further processed with emulsifier, lecithin, pregelatinized starch and gum to provide an egg replacer.

U.S. Pat. No. 4,182,779 describes a composition that can be used to extend egg yolk. It contains defatted soy flour with a PDI of less than 60, oil, grain flour, lecithin and a gum.

U.S. Pat. No. 4,296,134 describes a liquid egg blend which contains less than 1.25 wt % fat and which comprises 60-96 parts by weight (pbw) egg whites, 0-18 pbw water, 2-10.5 pbw protein replacement and small amounts of stabilizer, flavouring and colouring.

U.S. Pat. No. 4,360,537 and GB1 533084 disclose the preparation of a lipoprotein emulsion based on soy isolate that can be used to replace egg yolk in various food products. In the preparation, high amounts of soluble carbohydrates and lecithin are included. The preparation can be used e.g., for making cakes.

WO 2004/073 423 and US2004/0166230 are concerned with an egg replacer composition including a combination of proteins, oil and a restricted amount of carbohydrate, that has a low cholesterol content. It can be used, for example, for making omelettes.

However, in the prior art, the use of the disclosed egg substitutes caused changes in the recipe, formulation and processing of aerated food products, because the egg replacer was not able to sufficiently mimic all characteristics of eggs relevant to baking, or other cooking methods. Thus, egg replacers have not been readily accepted in the food industry. Other problems may arise because the use of a proposed egg replacer product may require complicated processing, sometimes requiring expensive equipment and/or the use of ingredients that are not readily available or expensive.

It is therefore an object of the invention to provide a novel and improved egg substitute composition and method of producing same for aerated and non-aerated products

### SUMMARY OF THE INVENTION

In accordance with one embodiment of the invention, there is provided an egg substitute composition for aerated food products, including wheat protein, emulsifiers, at least one fat or oil, and polysaccharides. Preferably, the composition also includes proteins and food gums.

According to one aspect of the invention, the egg substitute composition includes 1-60% wheat protein, 0-50% supplementary proteins, 1-30% emulsifiers, 1-30% fat or oil, 0-10% food gums and 5-30% polysaccharides.

According to another aspect of the invention, the wheat proteins are selected wheat vital gluten, wheat protein isolate and modified wheat protein.

According to another aspect of the invention, the supplementary proteins are selected from milk protein, soybean protein, peanut protein, sunflower protein, wheat protein isolate and hydrolyzed wheat protein.

According to another aspect of the invention, the emulsifiers are selected from propylene glycol ester, lecithin, monoglyceride, mono-diglyceride, sodium stearol lactylate, and other food emulsifiers, combinations of any thereof.

According to another aspect of the invention, the fat or oil has a melting point in the range of 20-50° C. and is selected from palm stearin, palm oil, butter, cocoa butter, soybean oil, peanut oil, palm oil, sunflower oil and other vegetable fats and oils. Alternatively, the fat or oil may be an animal fat.

According to another aspect of the invention the food gums are selected from xanthan gum, guar gum, carrageenan, gellan gum, gum arabic, glucomannan, locust bean gum, alginate and combinations of any thereof.

According to another aspect of the invention the composition includes ingredients with gelling temperatures in the range of 50-90° C., which can be select from starches and modified starches.

Preferably, the egg substitute composition according this embodiment includes 1-10 wt% moisture. The egg substitute composition according this embodiment is preferably used in preparing aerated food products.

According to another embodiment of the invention, there is provided a method for the emulsification of wheat protein for use in an egg substitute including the steps of:

a. heating at least one fat or oil with at least one emulsifier;

b. adding a wheat protein to the combination of fat or oil with at least one emulsifier of step a. to form a mixture; and,

c. cooling the mixture of step b. Optionally, after step a., the combination of fat or oil and at least one emulsifier is mixed.

According to one aspect of this embodiment, step a. includes heating to between 30-60° C. According to another aspect of this embodiment, step b. includes mixing continuously for between about 20-30 min at temperatures from 20-50° C. According to yet another aspect, step c. includes cooling to between about 15-30° C.

According to another embodiment of the invention, for non-aerated food products, there is provided an egg substitute composition including 40-90% of one or more of products of vital gluten protein, wheat protein isolate and modified gluten products.

According to an aspect of this embodiment, the composition includes 0-30% of one or more supplementary proteins selected from the group consisting of soybean protein isolate, soybean protein concentrate or other vegetable proteins such as peanuts protein products and sunflower protein products. The composition of this embodiment may also include a phosphate salt such as sodium phosphate or disodium phosphate.

According to another aspect of this embodiment, the composition may further include 0-3% of a reducing-oxidant agents selected from the group consisting of alkali metals, ammonium sulfites, bisulfites, metabisulfites, mercaptoethanol, cysteine, cystine and ascorbic acid.

According to another aspect of this embodiment, the composition further includes 0-30% of an emulsifier selected from the group consisting of propylene glycol ester, lecithin, monoglyceride, diglyceride, sodium stearol lactylate, and combinations of any thereof. Preferably, the emulsifier comprises from 0.1% to 30% by weight of the composition.

According to another aspect of this embodiment, the composition further includes at least 1-30% one oil or fat selected from the group comprising soybean oil, peanut oil, palm oil, sunflower oil and other vegetable oils and animal fats.

According to another aspect of this embodiment, the composition further includes 0.0-3% of calcium salt and ferrous salt respectively selected from the group consisting of calcium carbonate, calcium chloride and calcium sulphate, ferrouse gluconate and calcium lactate and combinations thereof.

According to another aspect of this embodiment, the composition further includes 0-10% food gums selected from the group consisting of xanthan gum, guar gum, carrageenan, gellan gum, gum arabic, glucomannan, locust bean gum and combinations thereof, and preferably 0.1-10% by weight of the composition.

Preferably, the composition of this embodiment is used in preparing non-aerated food products.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments will now be described, by way of example only, with reference to the attached Figures, wherein:

FIG. 1 shows one embodiment of a method for preparing an egg substitute according to the invention.

FIG. 2 is a comparative photograph of muffins prepared with a control sample and with egg substitutes according to the invention.

FIG. 3 is a comparative photograph of the interior of the muffins of FIG. 2.

FIG. 4 is a comparative photograph of cakes prepared with a control sample and with egg substitutes according to the invention.

FIG. 5 is a comparative photograph of the interior of the cakes of FIG. 4.

FIG. 6 is a comparative photograph of the interior of tea biscuits prepared with a control sample and with egg substitutes according to the invention.

FIG. 7 is a comparative photograph of brioches prepared with a control sample and with egg substitutes according to the invention.

FIG. 8 is a comparative photograph of the interior of the brioches of FIG. 7.

FIG. 9 is a comparative photograph of cookies prepared with a control sample and with egg substitutes according to the invention.

FIG. 10 is a comparative photograph of cooked fresh noodles prepared with a control sample and with egg substitutes according to the invention.

FIG. 11 is a comparative photograph of cooked Chinese Chow Main prepared with a control sample and with egg substitutes according to the invention.

### DETAILED DESCRIPTION OF THE EMBODIMENTS

The invention relates primarily to an egg substitute for use in aerated food products, but embodiments of the invention also describe an egg substitute for use in non-aerated food products. In this description, the terms egg replacer and egg substitute are used interchangeably and reference to one or the other of these terms should not be construed any differently. Various embodiments of an egg substitute are described herein with reference to ranges of particular elements making up the egg substitute composition. It will be appreciated by one skilled in the art that the egg substitute according to the invention includes variations falling within the ranges described and claimed, and the invention is not limited to particular examples described herein below.

A number of egg substitutes are herein provided which may be used as a replacer for eggs, egg yolk or egg powder in the production of aerated food products. Further examples and modifications are provided that may be used in the production of non-aerated food products. It is an object of the invention to mitigate at least one of the above-identified problems in the prior art. It is of particular benefit that the egg substitutes according to the invention are an improvement over prior art egg substitutes in that recipe changes are not required, or are otherwise minimized. Another benefit of the invention is to provide an egg substitute that reduces or eliminates the cholesterol content of food products. In all embodiments of the invention, it has been found to be beneficial to use wheat protein, or products thereof in providing an egg substitute according to the invention.

Egg Substitute for use with Aerated Food Products

According to an embodiment of the invention, there is provided an egg substitute for aerated food products that preferably includes wheat proteins, optionally other food proteins, emulsifiers, fats or oils, optionally food gums and other polysaccharides. According to a preferred embodiment, the egg substitute composition includes between about 1-60% wheat proteins, between about 0-50% other food proteins, such as milk proteins or soybean proteins, between about 1-30% emulsifiers, between about 1-30% fat (oil), between about 0-10% food gums and between about 5-30% of other polysaccharides.

The presence of wheat protein in the egg substitute composition has been found to be of particular benefit in testing by the inventor, as will be shown with reference to the examples detailed below. It has been found to be particularly beneficial for the egg substitute to include 1-60% wheat protein, which may be for example, wheat gluten protein, wheat protein isolate and/or modified what protein. The properties of wheat proteins are significantly modified during emulsification processing, as described below.

In order to provide for beneficial rheological properties of the egg substitute, between about 1-30% of fats or oils are provided, preferably selected from those with a melting point in the range of 20-50° C. and are selected to be vegetable-based fats or oils to provide for a vegetarian or vegan egg substitute. For example, these may include palm stearin, palm oil, butter, cocoa butter, soybean oil, peanut oil, palm oil, sunflower oil, and/or other vegetable fats and oils. In an alternate embodiment, the fats or oils may be selected from animal fats. A combination of various fats and oils may also be used.

The egg substitute also preferably includes between about 1-30% emulsifiers, preferably selected from the group consisting of propylene glycol ester, lecithin, monoglyceride, diglyceride, sodium stearol lactylate, and combinations of any thereof.

There may also be provided between about 0-50% supplementary proteins in the composition, which provide the emulsification and gelling properties of the egg substitute according to the invention that would be beneficial in certain baking applications. These supplementary proteins may be selected from soybean protein isolate, skim milk protein, whey protein isolate, whey protein concentrate, sodium caseinate, calcium caseinate, wheat protein isolate, and hydrolyzed wheat gluten protein.

In one preferred embodiment, the supplementary proteins are whey proteins, and especially a whey protein concentrate or a whey protein isolate containing 50-95% proteins. Alternatively the supplementary proteins may be provided from a dairy protein source, such as skimmed milk powder, sodium caseinate and calcium caseinate. Wheat protein isolate, wheat gluten protein and hydrolyzed wheat gluten protein have been found to provide especially preferred emulsification and gelling properties, which are of importance to a range of food products with different texture and baking (cooking) temperatures.

Soy protein may be preferred in the composition, preferably as soybean protein isolate. Soy protein isolate materials typically have a protein content of about 80% or more. Some egg replacers can use soybean flour and soybean protein concentrate and the combinations of thereof. Soy proteins are preferred for vegan egg substitutes.

The total protein content in the egg substitute composition for aerated food products, calculated on a dry basis is preferably between 30-75% and more preferably between 40-60%. The amount and type of proteins has a substantial influence on the gelling properties of the egg substitute cooked at different temperatures. Sometimes, a combination of proteins with modified starch may be used to improve the gelling properties of the egg substitute for a certain temperature and moistness of product. Various examples are described below. The combination of proteins and starch used also influences the structure development and organoleptic properties during preparation of the food product.

Optionally, the egg substitute composition according to the invention further includes 0-10% food gums to provide a viscosity to the egg replacer when it is hydrated in food production processing. In particular the amount of thickening polysaccharides, e.g., starches and gums such as pectin, carboxy methyl cellulose, xanthan gum and guar gum, in the egg substitute composition is preferably less than 1% of the composition. However, such gums, when present in small amounts, can make a positive contribution e.g. to stabilize air in the aerated food product.

Various other may include ancillary elements may be added to the egg substitute according to the invention such as flavor, seasoning, salt, food preservatives and calcium and iron supplements to mimic the flavor and nutritional value of eggs. The combined amount of ancillary elements preferably does not exceed 5% by dry weight, and more preferably it is between 0.3-3% by dry weight.

In order to provide for a longer shelf life and good storage stability, the egg substitute, in a concentrate form, preferably has a moisture content of less than 7%, and more preferably, less than 6%.

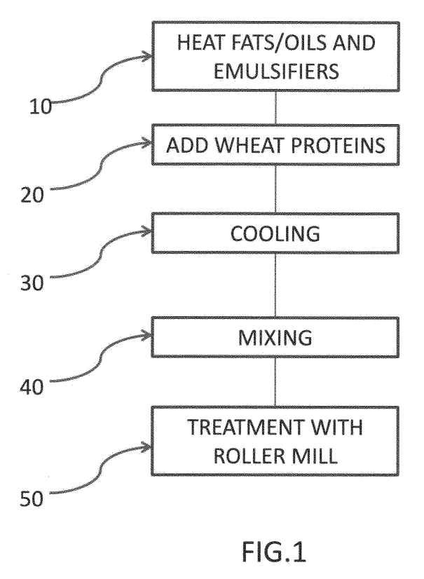

According to another embodiment of the invention there is provided a method for the preparation of an egg substitute as described above, and in particular, a method for the emulsification of wheat protein in the presence of a selective fat or oil and emulsifiers has been found to modify the rheological properties of wheat proteins by forming a wheat protein-emulsifier-fat complex. With reference to FIG. 1, there is shown a method for the preparation of an egg substitute according to the invention, and particularly a method for the emulsification of wheat protein for use in the egg substitute of the invention including the steps of heating selective fats or oils and emulsifiers 10, adding wheat protein proteins into the mixture of oil and emulsifiers 20 to produce a semisolid complex, and cooling the semisolid complex 30. In preparing the egg substitutes, the remaining ingredients selected for the specific application are then mixed in at step 40.

According to the preferred embodiment, step 10 includes heating the selective fats or oils with emulsifiers to between 30-60° C., and optionally mixing once heated, for example for approximately 10 minutes.

Step 20 preferably includes adding wheat proteins in into the mixture of oil and emulsifiers and continuously mixing for between 20-30 minutes at temperatures in the range of 20-50° C. Step 30 preferably includes cooling to a temperature of between 15-30° C.

Step 40 preferably includes mixing the remaining ingredients with the wheat proteins-fat or oil emulsifiers complex until a good distribution of all ingredients is obtained. The resulting concentrate is typically a powder or a paste, depending on the additional ingredients added.

Optionally, in step 50, the mixture may be treated by passing through a roller mill. This type of treatment reduces the particle size of the egg substitute.

Egg Substitute for use with Non-Aerated Food Products

According to a variation of the invention, adapted for providing an egg substitute for use with non-aerated food products, wheat protein materials are also used, and more particularly, wheat gluten protein materials which are able to improve the hardness and elasticity of food products prepared with the egg substitute according to the invention to more closely mimic the properties of real eggs when preparing food products. Only variations of the invention for adaptability with non-aerated food products are discussed below. Those elements that overlap or correspond with the description provided for aerated food products above are not repeated. Typically, providing the egg substitute for non-aerated food products will be provided in a liquid or liquid gel form.

Commercial wheat gluten protein products have too high of an elasticity after hydrated with water, as is the case for the majority of non-aerated food products. In most cases, this causes shrinkage of a dough sheet on the processing lines and directly affects the shape of non-aerated food products. Furthermore, there is not enough time for the added wheat gluten protein to get fully hydrated in non-aerated product processing, which leads to rough surfaces on dough sheet and on the finished product when the gluten protein products are added to the product formulation. As an aside, the strong elasticity of hydrated wheat gluten protein also has negative effects on the quality of aerated products, particularly on muffin and cake products, and therefore, the wheat gluten protein that may be used according to the invention must have a controlled preparation to provide the properties desired.

According to this embodiment, the wheat gluten protein may be mixed with 0-30% emulsifiers in the composition of egg replacer, which can be selected from propylene glycol ester, lecithin, monoglyceride, diglyceride, sodium stearol lactylate, and combinations of any thereof. The emulsifiers are able to influence the interaction of molecules of gluten proteins and in turn to reduce the elasticity of gluten proteins.

According to this embodiment, the wheat gluten protein may be also mix with 0-30% of food proteins with higher emulsion properties, for example, soybean protein insolate and soybean protein concentrate, to improve the ability of the wheat gluten protein to disperse in water and to reduce the interaction of gluten protein molecules, which therefore decreases the elasticity of the wheat gluten proteins. Furthermore, the pH of a liquid egg substitute is adapted to the wheat gluten proteins to form an egg like gel, which is preferably adjusted to an ideal pH with a base such as sodium hydroxide or potassium hydroxide. Generally, the base should be added to adjust the pH of the egg substitute to an ideal level of about 8-10, which is similar to pH of liquid egg. Such pH levels can also be achieved by using from about 0.01-1% solution of sodium phosphate or disodium phosphate if it is produced in liquid form.

The egg substitute for non-aerated food products also preferably includes reducing-oxidant agents, and preferably in an amount of 0.0-3% on flour base, in order to lower the average molecular weight of the wheat gluten proteins and also to cleave in a controlled way a proportion of the disulfide bonds between gluten proteins to increase the dispersing ability in water.

The incorporation of wheat gluten protein products with other vegetable proteins with strong emulsion ability enables this protein mixture to form a uniform mixture with a creamy texture when mixed with oil or fat and emulsifiers in liquid form.

The non-aerated food product egg substitute according to this embodiment also preferably contains calcium salt and ferrous salt such as calcium chloride, calcium lactate, calcium carbonate and calcium sulphate, ferrous sulphate, ferrous gluconate or combinations thereof

Overall, the egg replacers for non-aerated food products in this invention have properties similar to those of real egg and egg products in terms of water dispersing ability, emulsion ability and gelling properties. These may be used to improve the cooking and heating stabilities in the processing of non aerated products.

The egg substitutes for aerated products according to the invention are produced by first processing the proteins used by coating same with emulsified fats and/or oils to produce an egg yolk replacer, which has the same or similar emulsion and gelling properties of real egg yolk, suitable to the aerated products. The egg yolk substitute is cholesterol free, and is optionally able to be incorporated with egg white powder and fresh and frozen egg whites. Furthermore, egg yolk substitute may be mixed with vegetable proteins with high foaming ability and starches with good gelling ability, working as whole egg replacer.

### EXAMPLES

### Example 1

### Emulsification of Wheat Protein

The emulsification of wheat protein is carried out with selective fats and oils, and emulsifiers in an optimized formulation for processing. The formulation is shown in table 1:

TABLE 1

| Ingredient | % Dry Weight |
|---|---|
| Palm oil | 24.3 |
| Mono-diglyceride | 9.7 |
| Soybean lecithin | 17.5 |
| Wheat vital gluten | 48.5 |

The emulsification is carried out with the following steps:

Dry mixing ingredients at room temperature;

Heat up to 60° C., to melt the fats, oils and emulsifiers with a slow mixing;

Add the wheat protein components in the emulsified fat-oil mixture and keep mixing at the temperature 45-50° C.; and,

Cool down to 20° C.

This emulsified wheat protein may be used along with the examples that follow, or with the various embodiments of an egg substitute herein described.

### Example 2

### Egg Substitute used in a Muffin Product

Egg replacer A and egg replacer B were prepared with the formulation in table 2. Different amounts of complex of wheat protein-fat (oil)-emulsifiers is mixed with the selective components. The performance of egg replacer A and B was tested with a commercial muffin mix.

TABLE 2

| Ingredients | Egg replacer A (%) | Egg replacer B (%) |
|---|---|---|
| Complex of wheat vital | 47 | 49 |
| Soybean flour | 8.63 | 0 |
| Vital gluten protein | 21 | 15 |
| Xanthan gum | 1.4 | 0 |
| Whey protein isolate | 0 | 22 |
| modified starch | 4 | 0 |
| wheat flour | 18 | 15 |
| | 100 | 100 |

The Muffin was made with Quaker™ muffin mix with liquid eggs by following the instruction on the product label as the control test (test 1). In the test 2 and test 3, the liquid egg was replaced by egg replacers A and B, respectively, and additional water. 25% of the suggested liquid egg weight was provided in the form of the egg replacers and additional water was added to provide the remaining 75% of liquid egg weight.

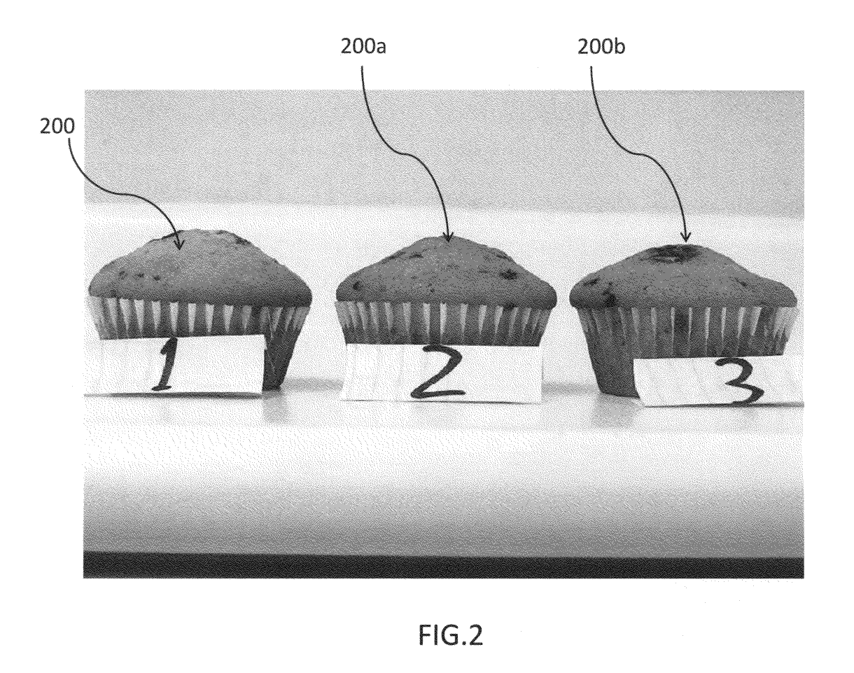

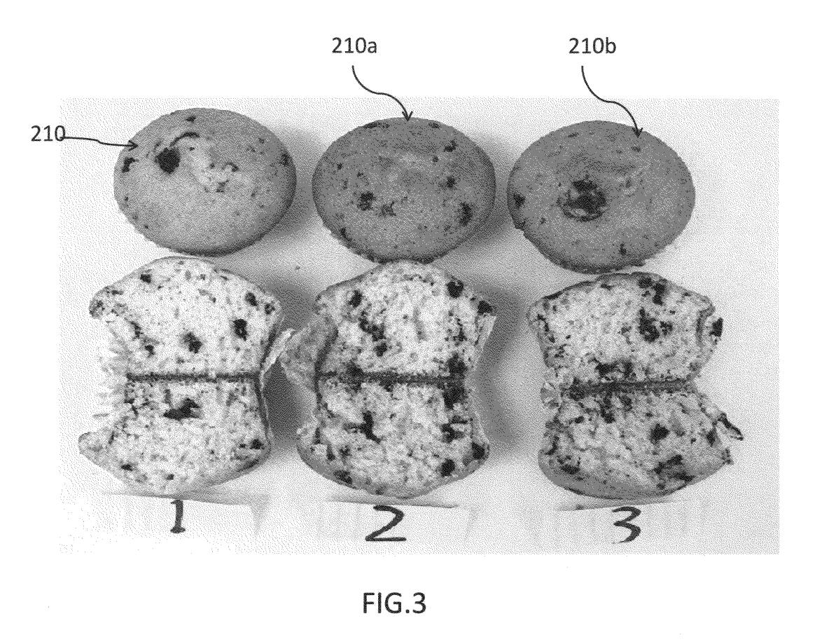

The test results are listed in the table 3 and shown in FIG. 2 and FIG. 3. It will be evident that the egg substitutes A and B are able to replace the liquid egg in the muffin product without significant noticeable changes.

TABLE 3

| | Test 1 | Test 2 | Test 3 |
|---|---|---|---|
| Quaker muffin mix | 3 cups | 3 cups | 3 cups |
| Water | 175 g | 175 g | 175 g |
| Liquid Egg | 50 g | 0 | 0 |
| Egg replacer A | 0 | 12.5 g | 0 |
| Egg replacer B | 0 | 0 | 12.5 g |
| Mixing | Mix with water and | Dry blending the | Dry blending the |
| | egg until all | muffin mix and egg | muffin mix and egg |
| | ingredients are | replacer A at speed 1, | replacer A at speed |
| | blended, then Spoon | then add the water and | 1, then add the water |
| | the batter into to | mix until the all | and mix until the all |
| | baking pans (60 g) | ingredients are | ingredients are |
| | | blended, then spoon | blended, then spoon |
| | | the batter into to | the batter into to |
| | | baking pans (60 g) | baking pans (60 g) |
| Baking | Bake at 200 C. (400 F.) | Bake at 200 C. (400 F.) | Bake at 200 C. (400 F.) |
| | for 17-19 min | for 17-19 min | for 17-19 min |
| Observations | Good color | Good color | Good color |
| | Good volume & | Good volume & | Good volume |
| | Txture | Texture | Texture is softer |
| | | | than test 1 and |
| | | | slightly dryer mouth |

FIG. 2 shows the general overall appearance of a muffin produced with liquid eggs 200, egg substitute A 200a and egg substitute B 200b. FIG. 3 shows the general overall texture of a muffin produced with liquid eggs 210, egg substitute A 210a and egg substitute B 210b.

### Example 3

### Egg Substitute in a Layer Cake

Egg substitute C was made by blending the complex of wheat vital gluten-fat (oil)-emulsifiers and plain flour at a 1:1 ratio as shown in Table 4

TABLE 4

| Ingredients | egg replacer C |
|---|---|
| Complex of wheat vital gluten-fat (oil)- | 50% |
| Plain flour | 50% |

As a control, the commercial Golden Deluxe™ cake mix, egg yolk powder and egg white powder were used. In test 1, the whole egg yolk power was replaced by the same amount of egg replacer C and in test 2, the egg yolk and egg white were replaced by the same amount of egg replacer B. The formulation, procedure and results are summarized in the table 5.

TABLE 5

| | | Test 1 | Test 2 |
|---|---|---|---|
| | Control (g) | Egg replacer C (g) | Egg replacer B |
| Golden Delux | 150 | 150 | 150 |
| cake mix | | | |
| Egg white | 4.2 | 4.2 | 0 |
| Egg yolk | 9.8 | 0 | 0 |
| Egg replacer C | | 9.8 | |
| Egg replacer B | | | 14 |
| water | 72 | 72 | 72 |
| Oil | 36 | 36 | 36 |
| Mixing | 30 S at low | 30 S at low speed | 30 S at low speed |
| | speed | 3 min speed 2 | 3 min speed 2 |
| | 2 min speed 2 | | |
| Baking 350 F. | 33 min | 33 min | 33 min |
| Height of Cake | 4.5 cm | 5 cm | 5 cm |

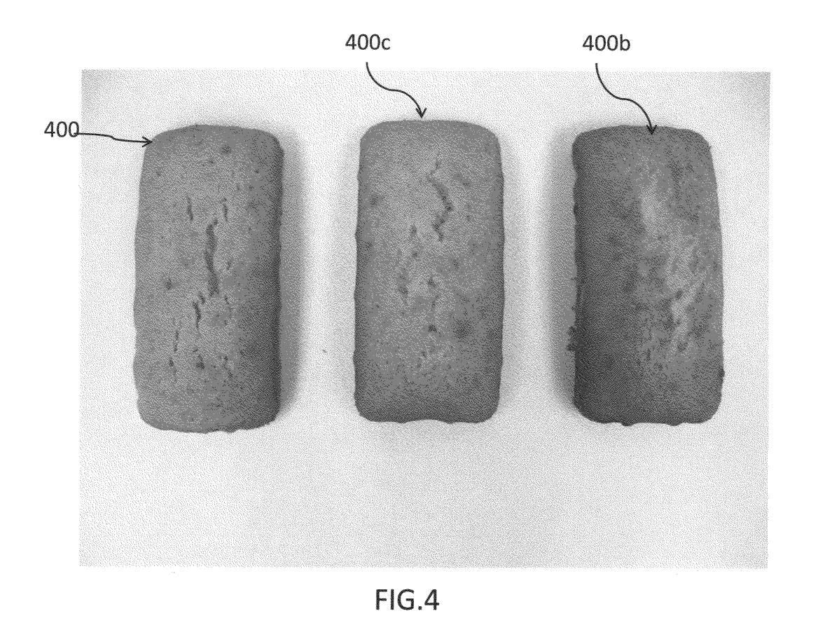

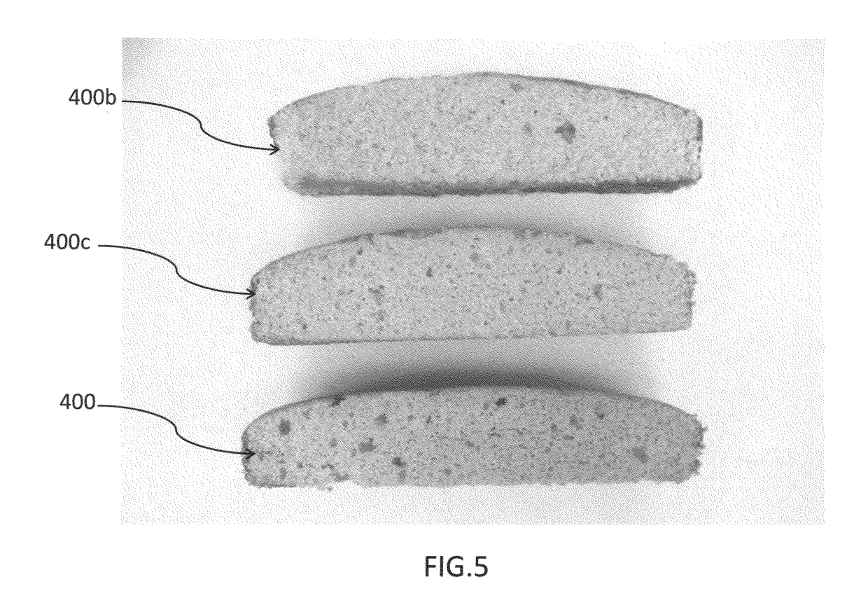

The volume of cake with egg substitutes C and B were slightly higher than that of the control. As can be seen from FIG. 4 and FIG. 5, the texture of cakes with egg replacer C 400c and egg replacer B 400b are similar to that of the control 400.

### Example 4

### Egg Substitute in Tea Bread

Traditional UK tea breads were made with liquid egg in a control sample. The liquid egg in the tea bread formulation was entirely replaced by egg replacer A and egg replacer B with water in testing samples. The formulations of tea bread with egg and with replacement of egg replacers are shown in table 6.

TABLE 6

| | Control | Egg replacer a | Egg replacer b |
|---|---|---|---|
| Plain flour (g) | 225 | 225 | 225 |
| Caster sugar (g) | 115 | 115 | 115 |
| Baking powder (g) | 1 tbsp | 1 tbsp baking | 1 tbsp |
| Salt | ½ tsp | ½ tsp | ½ tsp |
| Orange | 1 large | 1 large | 1 large |
| Fresh orange juice (ml) | 170 | 170 | 170 |
| Liquid egg (g) | 100 | 0 | 0 |
| Egg replacer A(g) | 0 | 25 | 0 |
| Egg replacer B (g) | 0 | o | 25 |
| Butter (g) | 85 | 85 | 85 |
| Dried cranberries (g) | 60 | 60 | 60 |
| Chopped walnuts (g) | 30 | 30 | 30 |

Tea bread was produced according to the following method: Preheat oven to 180° C.;

Sift the flour, sugar, baking powder and salt into a mixing bowl and dry blend well;

Add the orange, eggs and melted butter or margarine.;

Mix until the ingredients are blended;

Add the berries and walnuts and mix until blended;

Transfer the mixture to the prepared tin and bake for 45 to 50 minutes;

Cool in the tin for 10 minutes before transferring to a rack to cool completely.

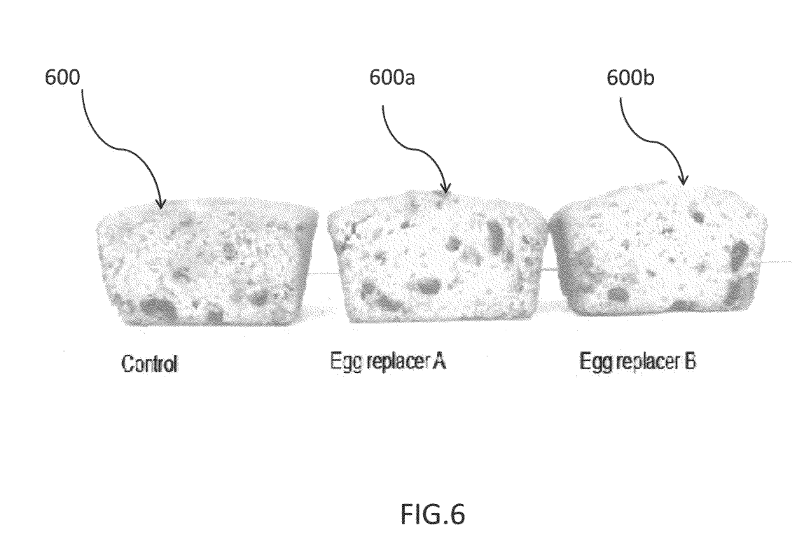

The appearance and texture of tea breads produced according to this example are shown in FIG. 6. It will be apparent that the tea bread with liquid egg 500 and with tea bread with the egg replacer A 600a and with the egg replacer B 600b have a similar volume. The structure of tea bread with egg replacer B was more uniform and closer to that of the control compared with that with egg repalcer A.

### Example 5

### Egg Substitute in a French Brioche

A French Brioche was made with liquid egg in a control sample, with egg substitute A and with egg substitute B, respectively. The liquid egg in the French brioche formulation was entirely replaced by egg replacer A and egg replacer B with water in the test samples

TABLE 7

| | Control | Egg replacer A | Egg replacer 2 |
|---|---|---|---|
| Strong flour (g) | 500 | 500 | 500 |
| Milk (g) | 55 | 55 | 55 |
| Yeast (g) | 55 | 55 | 55 |
| Salt (g) | 15 | 15 | 15 |
| Sugar (g) | 55 | 55 | 55 |
| Eggs (g) | 275 | | 62.5 |
| Egg replacer 1 | 0 | 62.5 | 0 |
| Egg replacer 2 | 0 | 0 | 62.5 |
| Butter (g) | 70 | 70 | 70 |
| Water | 0 | 212.5 | 212.5 |

The Brioche was prepared as follows:
1.) Add the dry ingredients (flour, sugar, salt) ;
2) Add eggs (or egg replacer with water), milk, yeast mix at speed 1 for 10 min;
3) Add the butter and mix at speed 2 for 5 min;
4) Cover and allow to ferment for 1 hour (24° C.);
5) Scale 300g of dough and model it;
6) Transfer the dough into baking tin and brush the top surface with egg wash;
7) Prove for 10-15min at 40° C.;
8) Bake in the oven at 460° F. (238° C.) for 25 min;
9) Remove bread and rolls from tins after baking;

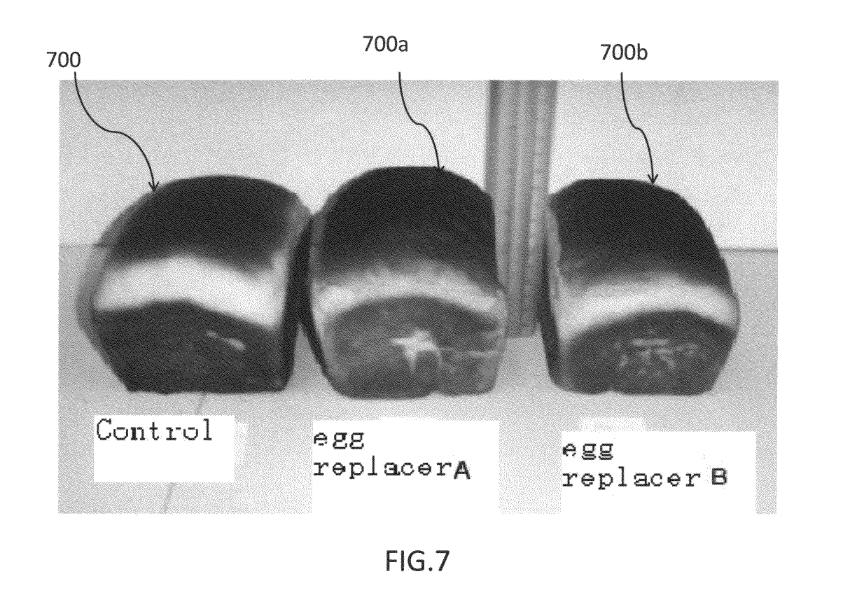

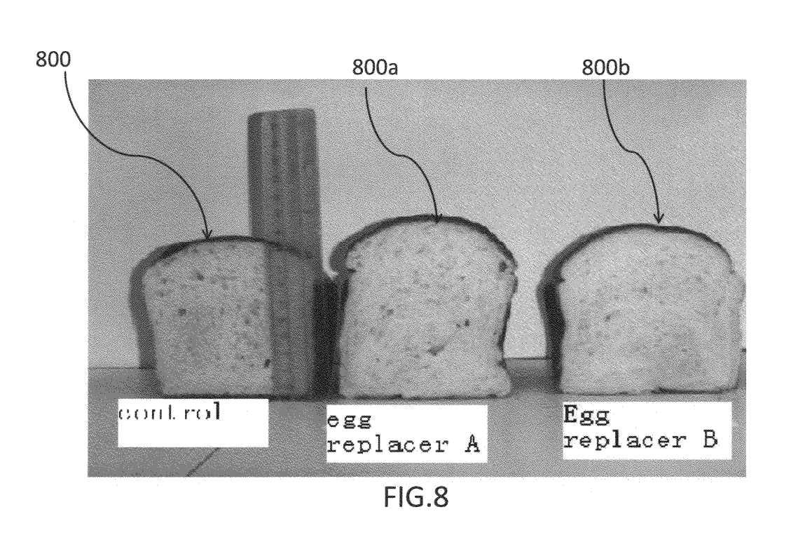

Photographss of the French Brioche with liquid egg (control) 700 and egg repalcer A 700a and egg replacer B 700b are shown in FIG. 7 and in FIG. 8. The volume of bread with egg replacer A is higher than the control and with egg repalcer B. The texture of bread appears almost indentical for the control sample and for those samples where an egg substitute according to the invention is used.

### Example 6

### Egg Substitute in Cookies

Egg substitute D was prepared with the formulation of Table 8. In the test, egg powder was entirely replaced by the egg replacer D at a 1:1 ratio.

TABLE 8

| Ingredient | % |
|---|---|
| Complex of wheat vital gluten-fat (oil)-emulsifiers | 49 |
| flour | 5 |
| Gluten | 15 |
| Whey protein isolate | 25 |
| Modified starch | 4.8 |
| Xanthan gum | 0.75 |
| CaCO3 | 0.45 |
| | 100 |

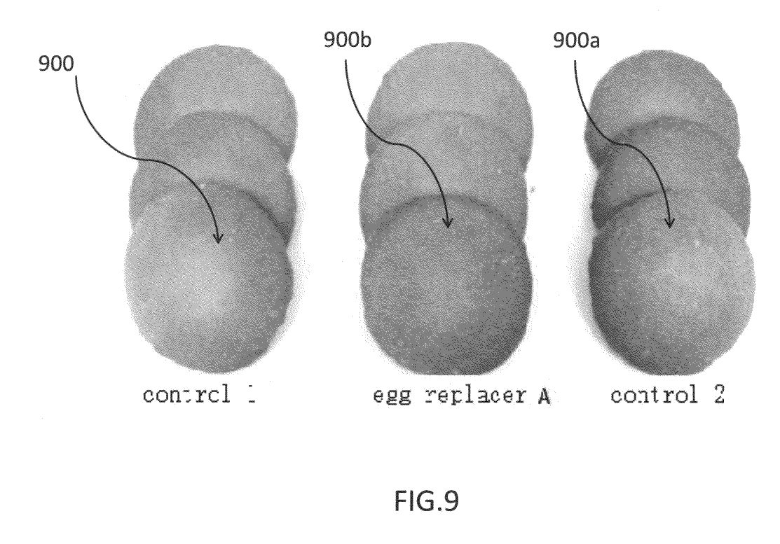

Photographs of the cookies with egg powder 900 in control sample 1, cookies with the egg powder 900a in control sample 2, and with egg replacer D 900d are shown in FIG. 9. The appearance, texture and colour of the cookies from both samples corresponded with each other.

The quality of cookies made with egg and with egg replacer D was also evaluated based a commercial standard. Two control samples were produced in this test. The results demonstrated the egg replacer was able to replace the egg in cookie products without noticeable changes in shape, color, product dimension, and moisture content.

TABLE 9

| | Control 1 | Egg replacer D | Control 2 |
|---|---|---|---|
| Dough weight (g) | 46 | 46 | 46 |
| Specific | 1.06 | 1.08 | 1.07 |
| Moisture % | 5.4 | 4.8 | 4.9 |
| Finish weight (g) | 36 | 36 | 35 |

### Example 7

### Egg Substitute in noodles

Egg substitute E was prepared with the formulation in Table 10. In the test, liquid egg was entirely replaced by the egg replacer E and F respectively at a 1:5 ratio.

TABLE 10

| Ingredients | % |
|---|---|
| CaCO3 | 2.46 |
| CaCL2 | 2.63 |
| L-Cystein | 0.11 |
| Soybean protein isolate | 28.49 |
| Vital wheat gluten | 61.40 |

The egg replacer has been applied in the formulation of Chinese noodle to replace the liquid egg as shown in Table 11.

TABLE 11

| | | | | | Egg |
|---|---|---|---|---|---|
| | Flour (g) | Water (g) | Salt (g) | Liquid egg (g) | replacer (g) |
| Control | 1000 | 276 | 15 | 100 | |
| Test 1 | 1000 | 350 | 15 | | 24 |

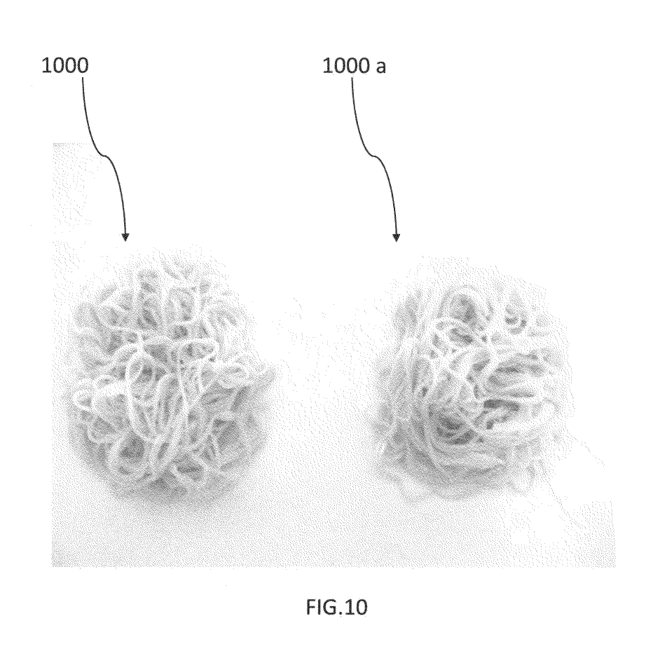

The photos in FIG. 10 show that the fresh noodle 1000 with the egg replacer has a similar appearance to that with regular eggs 1000a after cooking. This means the cooking stability, firmness and elasticity of noodles with egg replacer E were comparable to that with liquid egg.

The cooking stability and eating quality of noodles were evaluated and the resulate compared in Table 12.

TABLE 12

| | Boiling | Firm- | | Smooth- | | Total |
|---|---|---|---|---|---|---|
| | time | ness | Elasticity | ness | Appearance | marks |
| | | 25 | 25 | 25 | 25 | 100 |
| Control | 4 min | 22 | 22 | 25 | 25 | 93 |
| | 7 min | 20 | 22 | 22 | 25 | 88 |
| | 10 min | 20 | 20 | 20 | 23 | 83 |
| | 15 min | 20 | 18 | 18 | 20 | 77 |
| | | 0 | 0 | 0 | 0 | 0 |
| Test 1 | 4 min | 25 | 25 | 22 | 23 | 95 |
| | 7 min | 22 | 20 | 22 | 20 | 85 |
| | 10 min | 22 | 20 | 20 | 20 | 85 |
| | 15 min | 20 | 20 | 18 | 18 | 76 |

The results show that the noodles with egg replacer and liquid egg were comparable in terms of firmness, elasticity and smoothness and overall properties of noodles.

### Example 8

### Egg Substitute in Chinese Chow Main Product

The liquid egg replacer was prepared with the formulation in Table 13 and by following the method described below.

TABLE 13

| Ingredients | Weight (g) |
|---|---|
| Vital gluten | 314 |
| Soybean protein | 44 |
| Xathan gum | 8 |
| Calcium Chloride | 1.5 |
| SSL | 20 |
| Egg flavor | 1 |
| Color (yellow #5) | 0.5 |
| Total | 391 |
| Disodium phosphate | 0.1% 2000 |

Method for preparation of liquid egg replacer
a) Hydrate the powder of egg replacer with of 0.1% disoldium phosphate solution pH 8-9;
b) Slowly add the more 0.1% disoldium phosphate to achieve a certain viscosity and the protein content as same as the liquid egg;
c) Heat the resulted product up to 70° C. for 15-20 min or cook resulted product at 95° C. for 10 min;
d) Pack in sealed container at 70° C.;
e) Keep at the room temperature or in the refrigerator or freezer.

Chinese chow main was made at a batch size of 50 kg with 32% water and 5% liquid egg. After the flour was mixed with water and liquid egg, it was sheeted and cut, then steamed, cooled down to room temperature, then delivered to customers with various package sizes.

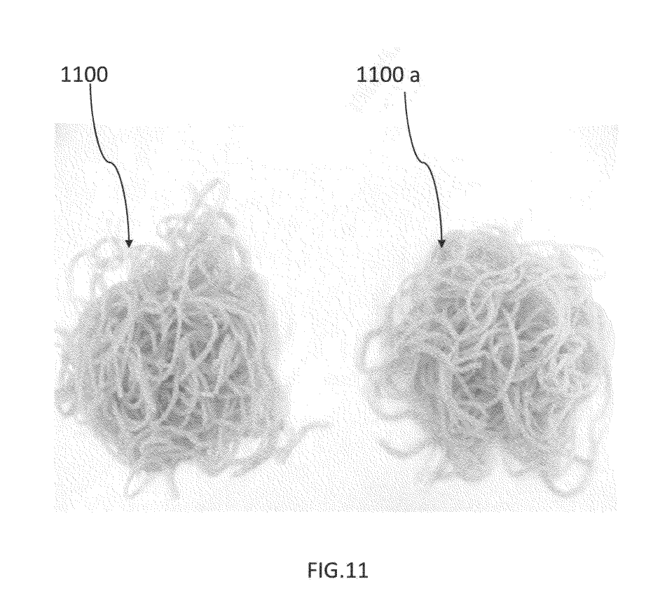

The liquid egg replacer replaced 100% of liquid egg in the production by 1:1 ratio. As shown in FIG. 11 the product with liquid egg replacer 1100a has no noticeable differences compared with the product with liquid egg 1100 to the customers.

Accordingly, with reference to the description provided here, and the above examples, it will be clear that the egg substitute provided by the invention simulates the cooking and/or baking properties of real eggs in a manner that allows for the substitution of the egg replacer according to the invention in practical applications. It will be understood by a person skilled in the art that various modifications to the invention may be made without departing from the spirit of the invention which is defined by the claims that follow. Furthermore, various substitutions of ingredients and element of the invention may be made.

The above-described embodiments are intended to be examples of the present invention and alterations and modifications may be effected thereto, by those of skill in the art, without departing from the scope of the invention that is defined solely by the claims appended hereto.

Having described the invention, the following is claimed:

1. An egg substitute composition comprising wheat protein, emulsifiers, at least one fat or oil, and polysaccharides.

2. An egg substitute composition according to claim 1, further comprising supplementary proteins.

3. An egg substitute composition according to claim 2, comprising 1-60% of said wheat protein, 0-50% of said supplementary proteins, 1-30% of said emulsifiers, 1-30% of said fat or oil, 0-10% food gums and 0-3% of calcium salt and 5-30% of said polysaccharides.

4. An egg substitute composition according to claim 3, wherein said wheat proteins are selected from the group comprising wheat vital gluten, wheat protein isolate and modified wheat protein.

5. An egg substitute composition according to claim 3, wherein said supplementary proteins are selected from the group comprising milk protein, soybean protein, peanut protein, sunflower protein, wheat protein isolate and hydrolyzed wheat protein.

6. An egg substitute composition according to claim 3, wherein said emulsifiers are selected from the group comprising propylene glycol ester, lecithin, monoglyceride, mono-diglyceride, sodium stearol lactylate, and combinations thereof.

7. An egg substitute composition according to claim 3, where said fat or oil has a melting point in the range of 20-50° C.

8. An egg substitute composition according to claim 7, wherein said fat or oil is selected from the group comprising palm stearin, palm oil, butter, cocoa butter, soybean oil, peanut oil, palm oil, sunflower oil and other vegetable fats and oils.

9. An egg substitute composition according to claim 7, wherein said fat or oil comprises an animal fat.

10. An egg substitute composition according to claim 3, wherein said food gums are selected from the group comprising xanthan gum, guar gum, carrageenan, gellan gum, gum arabic, glucomannan, locust bean gum and combinations of any thereof.

11. An egg substitute composition according to claim 3, further comprising ingredients with gelling temperatures in the range of 50-90° C.

12. An egg substitute composition according to claim 11, wherein said ingredients are selected from the group comprising starches and modified starches.

13. An egg substitute composition according to claim 1, comprising 1-10 wt % moisture.

14. An egg substitute composition according to claim 1, where said composition is used in preparing aerated food products.

15. A method for the emulsification of wheat protein for use in an egg substitute comprising:
a. heating at least one fat or oil with at least one emulsifier;
b. adding a wheat protein to said combination of fat or oil with at least one emulsifier of step a. to form a mixture;
c. cooling said mixture of step b.

16. A method according to claim 15, wherein step a. includes heating to between 30-60° C.

17. A method according to claim 16, wherein after step a., mixing said combination of fat or oil and at least one emulsifier.

18. A method according to claim 15, wherein step b. includes mixing continuously for between about 20-30 min at temperatures from 20-50° C.

19. A method according to claim 15, wherein step c. includes cooling to between about 15-30° C.

20. An egg substitute composition comprising one or more selected from the group consisting of products of vital gluten protein, wheat protein isolate and modified gluten products.

21. An egg substitute composition according to claim 20, further comprising one or more supplementary proteins selected from the group consisting of soybean protein isolate, soybean protein concentrate or other vegetable proteins such as peanuts protein products and sunflower protein products.

22. An egg substitute as claimed in any one of claim 20, further comprising reducing oxidant agents selected from the group consisting of alkali metals, ammonium sulfites, bisulfites, metabisulfites, mercaptoethanol, cysteine, cystine and ascorbic acid.

23. An egg substitute as claimed in claims of 20, further comprising an emulsifier selected from the group consisting of propylene glycol ester, lecithin, monoglyceride, diglyceride, sodium stearol lactylate, and combinations of any thereof.

24. An egg substitute composition as claimed in claims 20, further comprising at least one oil or fat selected from the group comprising soybean oil, peanut oil, palm oil, sunflower oil and other vegetable oils or animal fats.

25. An egg substitute composition according to claim 20 further comprising a calcium salt and ferrous salt selected from the group consisting of calcium carbonate, calcium chloride, calcium sulphate and calcium lactate, ferrous sulphate, ferrous gluconate and combinations thereof.

26. An egg substitute as claimed in claim 20,further comprising the food gums selected from the group consisting of xanthan gum, guar gum, carrageenan, gellan gum, gum arabic, glucomannan, locust bean gum and combinations thereof.

27. An egg substitute composition according to claim 20 further comprising a phosphate salt such as sodium phosphate or disodium phosphate if it is produced in liquid form.

28. An egg substitute composition according to claim 20, comprising 40-90% of said wheat protein, 0-30% of said supplementary proteins, 0-30% of said emulsifiers, 1-30% of said fat or oil, 0-10% of said food gums and 0.01-5% of said calcium and ferrous salts and 5-30% of said polysaccharides.

29. An egg substitute composition according to claim 20, further comprising 0.01-1% of sodium phosphate or disodium phosphate.
